(19) United States
(12) Patent Application Publication
(10) Pub. No.: US 2014/0307574 A1
(43) Pub. Date: Oct. 16, 2014

(54) COMMUNICATION CONNECTION CONTROL METHOD AND ELECTRONIC APPARATUS SUPPORTING THE SAME

(71) Applicant: Samsung Electronics Co., Ltd., Suwon-si (KR)

(72) Inventors: Jongmu CHOI, Seongnam-si (KR); Kiseok KANG, Pyeongtaek-si (KR); Changyeon YEO, Suwon-si (KR); Yonghae CHOI, Hwaseong-si (KR)

(73) Assignee: Samsung Electronics Co., Ltd., Suwon-si (KR)

(21) Appl. No.: 14/256,534

(22) Filed: Apr. 18, 2014

(30) Foreign Application Priority Data
Mar. 13, 2013 (KR) 10-2013-0026962

(51) Int. Cl. H04W 24/02; H04W 84/12

(52) U.S. Cl. CPC H04W 24/02; H04W 84/12
USPC 370/252

(57) ABSTRACT

A communication connection control method is provided. The method includes collecting a wireless access point-related signal relating to a wireless environment of a wireless access point, determining whether the wireless access point-related signal is in a state having a value lower than or equal to a pre-configured value, performing a wireless communication performance evaluation of a system including a communication network connected to the wireless access point according to a result of the determining, and performing a control to deactivate a communication connection based on the wireless access point according to a result of the wireless communication performance evaluation.

### CROSS-REFERENCE TO RELATED APPLICATION(S)

This application claims the benefit under 35 U.S.C. §119(a) of a Korean patent application filed on Mar. 13, 2013 in the Korean Intellectual Property Office and assigned Serial number 10-2013-0026962, the entire disclosure of which is hereby incorporated by reference.

### TECHNICAL FIELD

The present disclosure relates to a communication connection control. More particularly, the present disclosure relates to a communication connection control method, which supports a wireless access point-based communication connection control, and an electronic apparatus supporting the same.

### BACKGROUND

Recently, electronic apparatuses have a communication function and are used by many people due to their small sizes allowing them to be portable. These electronic apparatuses are enjoying dramatic development owing to the recent trend of enlargement of their touch screens together with the support of hardware and software capable of providing various contents.

These conventional electronic apparatuses are equipped with various communication modules and support various communication services based on the equipped communication modules.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a communication connection control method and an electronic apparatus supporting the same, which can achieve an actual service improvement in a communication connection control environment based on various communication modules.

In accordance with an aspect of the present disclosure, a communication connection control method is provided. The communication connection control method includes collecting a wireless access point-related signal relating to a wireless environment of a wireless access point, determining whether the wireless access point-related signal is in a state having a value lower than or equal to a pre-configured value, performing a wireless communication performance evaluation of a system including a communication network connected to the wireless access point according to a result of the determining, and performing a control to deactivate a communication connection through the wireless access point according to a result of the wireless communication performance evaluation.

In accordance with another aspect of the present disclosure, a communication connection control method is provided. The communication connection control method includes collecting a signal relating to a wireless environment of a wireless access point in a connection state configured to a deactivated state, determining whether the signal relating to the wireless environment of the wireless access point has an intensity higher than a pre-configured value, performing a wireless communication performance evaluation of a system including a communication network connected to the wireless access point according to a result of the determining, and performing a control to activate a communication connection based on the wireless access point according to a result of the wireless communication performance evaluation.

In accordance with another aspect of the present disclosure, an electronic apparatus for performing a communication connection control is provided. The electronic apparatus includes a WiFi module that collects a wireless access point-related signal relating to a wireless environment of a wireless access point, and a controller that determines whether the wireless access point-related signal is in a state having a value lower than or equal to a pre-configured value, performs a wireless communication performance evaluation of a system including a communication network connected to the wireless access point according to a result of the determining, and performs a control to deactivate a communication connection based on the wireless access point according to a result of the wireless communication performance evaluation.

In accordance with another aspect of the present disclosure, an electronic apparatus for performing a communication connection control is provided. The electronic apparatus includes a WiFi module that collects a signal relating to a wireless environment of a wireless access point in a connection state configured to a deactivated state, and a controller that determines whether the signal relating to the wireless environment of the wireless access point has an intensity higher than a pre-configured value, performs a wireless communication performance evaluation of a system including a communication network connected to the wireless access point according to a result of the determining, and performs a control to activate a communication connection based on the wireless access point according to a result of the wireless communication performance evaluation.

As described above, a communication connection control method and an apparatus supporting the same according to an embodiment of the present disclosure can support sufficient utilization of an effective communication service environment and thus can achieve an effective communication connection control.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 schematically illustrates a wireless communication environment according to an embodiment of the present disclosure;

FIG. 2 is a block diagram illustrating a configuration of the electronic apparatus of FIG. 1 in more detail according to an embodiment of the present disclosure;

FIG. 3 is a block diagram illustrating a configuration of the controller of the electronic apparatus of FIG. 2 in more detail according to an embodiment of the present disclosure;

FIG. 4 is a flowchart illustrating a method of deactivating a connection with a particular wireless access point in a communication connection control method according to an embodiment of the present disclosure;

FIG. 5 is a flowchart illustrating a method of activating a connection with a deactivated wireless access point in a communication connection control method according to an embodiment of the present disclosure; and

FIGS. 6A and 6B are views for describing change of wireless connection areas according to a communication connection control according to an embodiment of the present disclosure.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing various embodiments of the present disclosure, descriptions of technical contents that are well-known in the art to which the present disclosure pertains and are not directly associated with the present disclosure will be omitted. Moreover, detailed descriptions related to configuration elements having substantially identical configurations and functions will be omitted.

For a similar reason, some elements in the attached drawings may be illustrated to be exaggerated or omitted, or may be schematically illustrated, and the size of each component element may not completely reflect its actual size. Accordingly, the present disclosure is not restricted by the relative size or interval of the elements illustrated in the accompanying drawings.

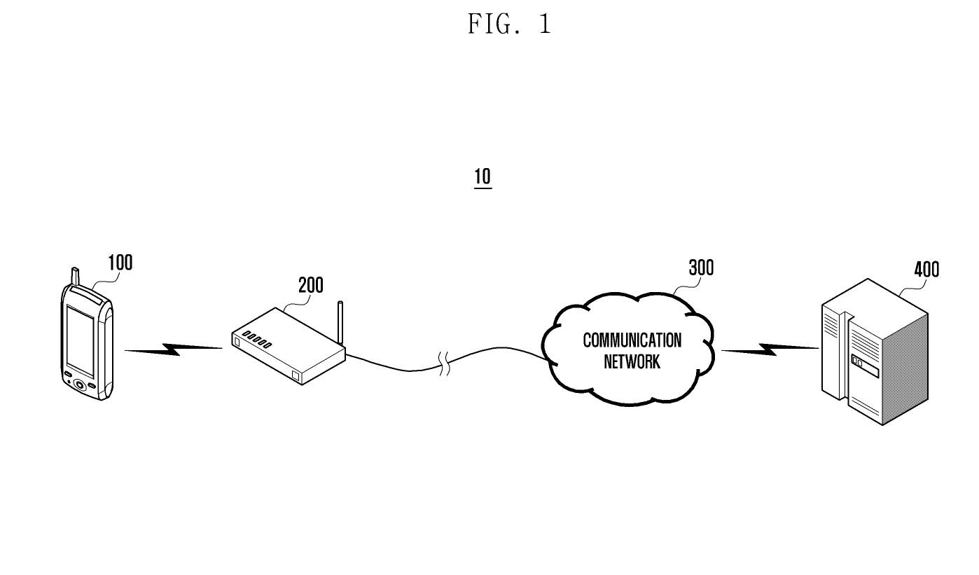

FIG. 1 schematically illustrates a communication use environment 10 for describing a communication connection control of an electronic apparatus according to an embodiment of the present disclosure.

Referring to FIG. 1, the communication use environment 10 may include at least one wireless access point 200, an electronic apparatus 100, a communication network 300, and a server apparatus 400. Further, the communication use environment 10 may further include a base station for supporting a particular communication scheme, e.g. a third Generation (3G) or fourth Generation (4G) communication scheme, of the electronic apparatus 100. Then, the electronic apparatus 100 can access the communication network 300 through at least one of the wireless access point 200 and the base station.

In the communication use environment 10 including such a construction as described above, the electronic apparatus 100 can establish a communication channel with the wireless access point 200 and access the communication network 300 through the wireless access point 200. Further, the electronic apparatus 100 can establish a communication connection with the server apparatus 400 through the communication network 300 and may then request the server apparatus 400 to provide particular information or may upload particular information to the server apparatus 400. In this process, the electronic apparatus 100 may check the communication state of the connection between the wireless access point 200 and the communication network 300 and control the connection of the wireless access point 200. That is, in the process of determining the communication state of the communication service through the wireless access point 200, the electronic apparatus 100 may determine not only the connection state with the wireless access point 200 but also the actual communication service state to control the connection with the wireless access point 200.

The wireless access point 200 may be an apparatus supporting the wireless connection of the electronic apparatus 100 through, for example, a Wireless Local Area Network (WLAN) or WiFi. The wireless access point 200 as described above may be connected to the communication network 300, such as an Internet network. Further, the wireless access point 200 can allow access to a plurality of electronic apparatuses 100 and support the accessed electronic apparatuses 100 to connect with the communication network 300. In this process, the wireless access point 200 can provide a predetermined signal in order to connect with and maintain the connection with the electronic apparatuses 100. For example, the wireless access point 200 may provide a control signal, such as a beacon signal. At least one wireless access point 200 as described above may be disposed in a predetermined area according to the intention of a service provider. The wireless access point 200 has a wireless coverage area, and the connection may be released when the electronic apparatus 100 leaves from the coverage area. The wireless access point 200 can allocate predetermined channels to a plurality of electronic apparatuses 100 and transfer data provided by the electronic apparatuses 100 to the communication network 300. Although only one wireless access point 200 is disposed in FIG. 1, the present disclosure is not limited thereto. That is, a plurality of wireless access points 200 may be disposed in a predetermined area.

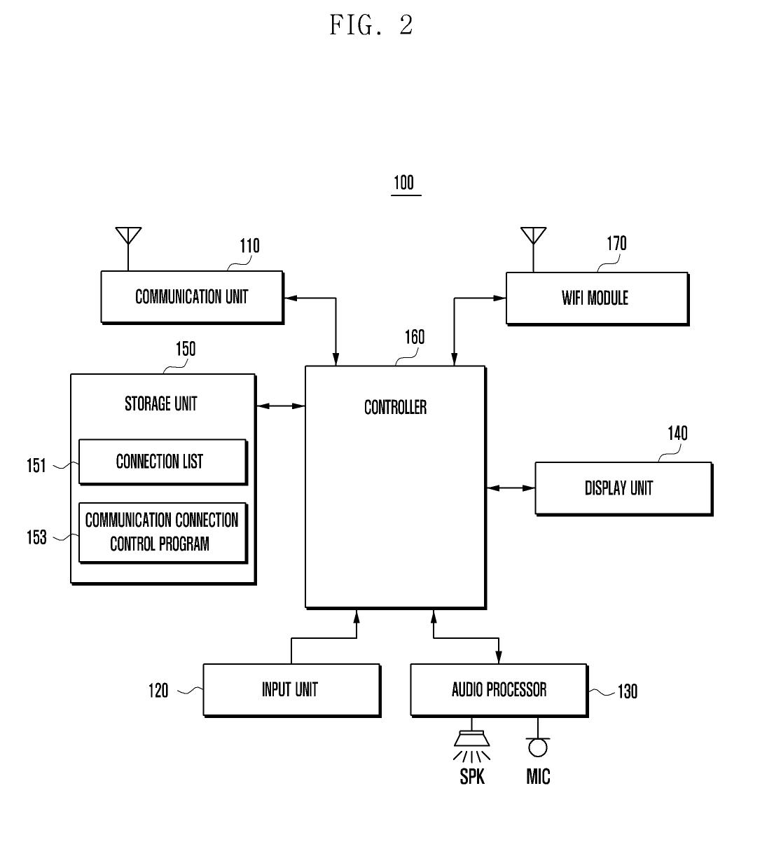

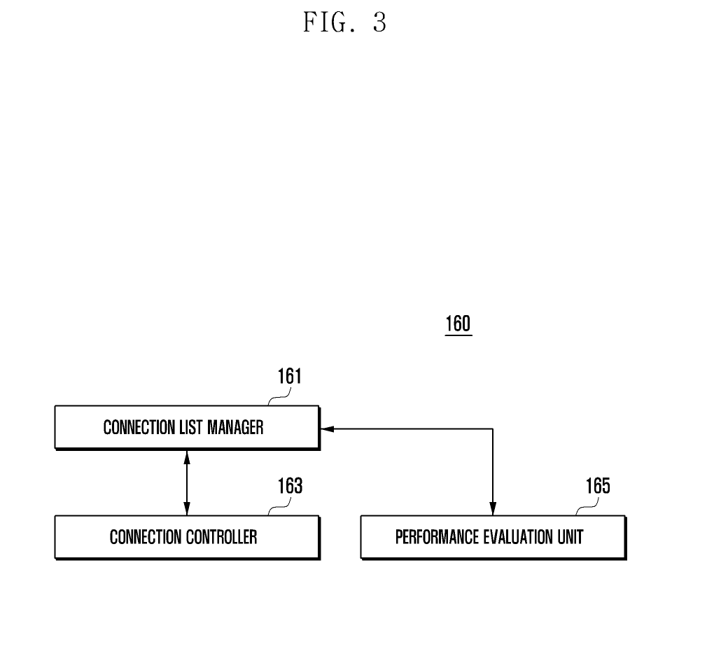

The electronic apparatus 100 may be an apparatus that can connect with the communication network 300 through the wireless access point 200. Further, the electronic apparatus 100 can access the communication network 300 through a base station. To this end, the electronic apparatus 100 may include a plurality of communication modules and adaptively change the communication module according to the wireless environment. In this event, the electronic apparatus 100 according to the present disclosure can identify an actual communication service state through the wireless access point 200 and control the communication scheme change according to the identified communication service state. For example, when the actual communication service state through the wireless access point 200 does not exceed a predetermined threshold, the electronic apparatus 100 may release the communication connection with the wireless access point 200. Further, the electronic apparatus 100 may perform a communication connection with a communication network 300 employing a different communication scheme, such as 3G or 4G communication scheme. Further, the electronic apparatus 100 can identify a wireless environment change of the wireless access point 200, and can control the communication connection to the wireless access point 200 when the wireless environment has been improved to have a value exceeding a predetermined threshold. Through the above process, the electronic apparatus 100 can control maintenance or change of a communication scheme or maintenance or change of a communication access point based on not only the communication state between the electronic apparatus 100 and the wireless access point 200 but also the actual communication service state between the wireless access point 200 and the communication network 300. The electronic apparatus 100 as described above will be described hereinafter in more detailed with reference to FIGS. 2 and 3.

The communication network 300 may be configured by network apparatuses connected with the wireless access point 200 based on at least one scheme among wireless and wired schemes in a communication use environment 10. The communication network 300 may be connected to a base station described above. Therefore, the communication network 300 may be understood as an element arranged as at least one of various network apparatuses for supporting a communication service of the communication network 300. The communication network 300 can establish an Internet network or Intranet network, and support data transmission or reception of the electronic apparatus 100 connected through a base station or the wireless access point 200. The communication network 300 may support establishment of a communication channel between the server apparatus 400 and the electronic apparatus 100. Further, the communication network 300 can support transfer of data from the server apparatus 400 to the electronic apparatus 100 through the wireless access point 200.

The server apparatus 400 may be at least one of wireless and wired apparatuses that can be connected to the communication network 300. The server apparatus 400 can receive information stored in the electronic apparatus 100 through the communication network 300. Further, the server apparatus 400 can transmit information required by the electronic apparatus 100 through the communication network 300. The server apparatus 400 can receive a particular test signal from the electronic apparatus 100. Then, the server apparatus 400 can provide response data with a predetermined capacity to the electronic apparatus 100 in response to the test signal. The server apparatus 400 may be an element for determining an actual communication service state of the wireless access point 200 by the electronic apparatus 100. Therefore, the server apparatus 400 may be a server apparatus separately constructed in order to support access and data transmission/reception test of the electronic apparatus 100. Further, the server apparatus 400 may be a server apparatus of a service provider that provides a general commercial service. Further, the test signal may be a signal for requesting the server apparatus 400 to provide data having a predetermined capacity. In order to activate or deactivate the connection to the wireless access point 200 of the electronic apparatus 100, the server apparatus 400 may provide a uniform data transmission rate based on a particular protocol to each electronic apparatus 100.

Hereinafter, elements and functions of the elements of the electronic apparatus 100 will be described in more detailed with reference to the accompanying drawings.

FIG. 2 is a block diagram illustrating the construction of the electronic apparatus 100 according to an embodiment of the present disclosure in more detail.

Referring to FIG. 2, the electronic apparatus 100 of the present disclosure may include a communication unit 110, an input unit 120, an audio processor 130, a display unit 140, a storage unit 150, a WiFi module 170, and a controller 160.

The electronic apparatus 100 having the construction described above can search for nearby wireless access points by using the WiFi module 170. Further, the electronic apparatus 100 can switch the communication connection with a corresponding access point into a deactivated state when an actual communication service environmental value, e.g. a particular protocol-based data transmission rate, of a found wireless access point is lower than or equal to a pre-configured threshold value. Further, when there is a change in the communication environment of the wireless access point, for example, when a signal having an intensity value larger than or equal to a configured threshold received signal intensity value, the electronic apparatus 100 re-determines whether to activate the connection with the wireless access point. In the process of re-determining whether to activate the connection, the electronic apparatus 100 may activate the connection with the wireless access point according to the data transmission rate based on a particular protocol through the wireless access point. That is, the electronic apparatus 100 can maintain the activated connection with the wireless access point or deactivate the connection with the wireless access point according to the data transmission rate between entities including the wireless access point and the communication network 300. As a result, the electronic apparatus 100 can control the communication connection through the wireless access point based on a determination on an actual data transmission state as well as the signal transmission/reception intensity with the wireless access point.

The communication unit 110 may be various types of communication modules according to the type of support of the electronic device 100. For example, the communication module 110 may be implemented as at least one type of module among a wireless communication module, a wired communication module, and a mobile communication module. The communication unit 110 is an element that can be omitted when the electronic apparatus 100 supports a communication function based on only the WiFi module 170. The communication unit 110 may include at least one communication module that can establish a communication with a 2G network apparatus, a 3G network apparatus, or a 4G network apparatus and can support the same communication service as the communication service provided based on the WiFi module 170. The communication unit 110 may switch the data communication service channel through the communication unit 110 into a deactivated state when the WiFi module 170 is activated, and the data communication channel is thus established while the communication unit 110 supports a data communication service using a particular communication channel according to user operation. Further, when the WiFi module 170 is in the deactivated state, the communication unit 110 may automatically shift to an activated state and establish a communication channel with the communication network 300 through the communication module.

The input unit 120 generates various input signals required for operation of the electronic apparatus 100. The input unit 120 may include various configurations according to input signal generation support types of the electronic device 100. For example, when the display unit 140 is arranged in the form of a touch screen, the input unit 120 may include a display panel outputting a virtual touch pad or touch key map and a touch panel defining a touch area on the display panel. Further, the input unit 120 may include a keypad, a side key, a home key or the like. Further, the input unit 120 may include a pen touch panel arranged in order to support a touch pen and a touch pen operation.

The input unit 120 may generate an input signal for requesting activation of the WiFi module 170 in response to a user request. Further, when the communication connection control function of the present disclosure supports a manual mode, the input unit 120 may generate an input signal for searching for a connection list 151 stored in the storage unit 150 and an input signal for manually appointing a particular wireless access point included in the connection list 151. Further, the input unit 120 may generate an input signal for requesting a shift from a communication connection state based on the WiFi module 170 to communication connection state based on the communication unit 110. A generated input signal may be transferred to the controller 160 to operate as a command for execution of a corresponding function according to the input signal.

The audio processor 130 includes a speaker in order to support various audio data outputs according to the operation of the electronic apparatus 100. When the electronic apparatus 100 supports a voice call function or a recording function, the audio processor 130 may include a microphone for collecting audio data. When an input signal requesting activation of the WiFi module 170 occurs, the WiFi module 170 is activated to scan the surroundings. In this event, the audio processor 130 may support output of a guide sound relating to a connection activated state or connection deactivated state with a particular wireless access point included in the connection list 151. Further, when the connection with the wireless access point is changed from an activated state to a deactivated state or from a deactivated state to an active state, the audio processor 130 may output a corresponding guide sound or effect sound. The above-described function of outputting the guide sound effect sound may be omitted according to a designer's intention or a user's configuration.

The display unit 140 may output various screens necessary for an operation of the electronic device 100. For example, the display unit 140 may output a particular web service screen connected through the communication unit 110 or the WiFi module 170. In this event, the display unit 140 may output an icon or indicator indicating a connection state through the communication unit 110 or an icon or indicator indicating a connection state through the WiFi module 170. In order to support an input function further to the display function, the display unit 140 may be configured to include a touch panel and a display panel and may support configuration of an effective area of the touch panel corresponding to various virtual key maps.

The display unit 140 may provide a screen for outputting a connection list 151. The connection list providing screen may include information on connection activation of a wireless access point. Further, the connection list providing screen may include deactivation information on a wireless access point having at least one connection deactivated state. The deactivation information may include at least one piece of information among information on a time point at which and a time interval passed after the connection with a wireless access point is changed into a deactivated state, information on a reason for the change into a deactivated state, and deactivation history information relating to the connection with the wireless access point. The display unit 140 may support output of a corresponding message when the connection state of the wireless access point changes into a connection activated state or a connection deactivated state. For example, the display unit 140 may output information on a connection state with the wireless access point through output of a pop-up message in a particular user function screen state independently from the connection list output screen. Further, the display unit 140 may change and output an indicator corresponding to the wireless access point. That is, when the connection with the wireless access point has been changed into a deactivated state, the display unit 140 may output a corresponding indicator in an indicator area.

The storage unit 150 may store programs necessary for operations of the electronic apparatus 100 of the present disclosure and programs relating to various functions supported by the electronic apparatus 100 and may store data according to support of the programs or operations of the programs. Especially, the storage unit 150 may store a connection list 151 including information on at least one wireless access point classified into an activated state or a deactivated state based on the data transmission rate. Further, the storage unit 150 may store a communication connection control program 153 for operation of the communication unit 110 and the WiFi module 170.

The connection list 151 may include information on wireless access points, to which the electronic apparatus 100 is connected, and information on deactivated wireless access points, to which the electronic apparatus 100 cannot be connected, among the scanned nearby wireless access points. Further, the connection list 151 may include history relating to the scanned wireless access points. The history may include connection activation and deactivation history information with the wireless access points.

The communication connection control program 153 may store routines supporting a wireless access point connection control of the present disclosure. For example, the communication connection control program 153 may include a routine for activating the WiFi module 170 in response to a user input or according to configured information and a routine for scanning nearby wireless access points by using the WiFi module 170. Further, the communication connection control program 153 may include a routine for comparing identification information of the scanned wireless access points with the connection list 151, a routine for removing at least one wireless access point registered as a deactivated wireless access point from the connection list 151, and a routine for trying to connect to at least one scanned wireless access point excluding the deactivated wireless access point.

Further, the communication connection control program 153 may include a routine for controlling establishment of a communication channel through the communication unit 110 when there is no wireless access point to be connected. Further, the communication connection control program 153 may include a routine for re-scanning at least one wireless access point and re-trying to connect to the wireless access point by a predetermined cycle according to the design scheme. Otherwise, the communication connection control program 153 may include a routine for supporting maintenance of a communication connection based on the communication unit 110 until another user input is made when the connection has failed once or several times according to the design scheme.

The WiFi module 170 may be one of various types of communication modules arranged to be capable of accessing a wireless access point. The WiFi module 170 can search for and try to connect to a wireless access point, which is not in a deactivated state, in response to an activation request from a user or according to information configured in a program. The WiFi module 170 may be operated either independently from or alternately with the connection to a mobile communication network supported by the communication unit 110. That is, the WiFi module 170 may be in a deactivated state when the communication unit 110 establishes a communication channel, and the electronic apparatus 100 may be in a deactivated state when the WiFi module 170 is switched into an activated state according to a user request. Further, when there is a connection release of the WiFi module 170 or a connection deactivation with a wireless access point, a communication channel based on the communication unit 110 may be established and operated. The WiFi module 170 may receive a predetermined signal e.g. a beacon signal, from the wireless access point and provide the received signal to the controller 160. Further, the WiFi module 170 may perform connection to the communication network 300 through the wireless access point according to a control of the controller 160 and transfer a query, etc. according to a request from the controller 160 to the server apparatus 400 connected to the communication network 300.

The controller 160 may support general signal flow, data processing, data transfer, and data storage relating to the operation control of the electronic apparatus 100. Especially, the controller 160 can control searching for and access to a wireless access point, and a process after the access according to the present disclosure. To this end, the controller 160 may include a configuration as illustrated in FIG. 3.

FIG. 3 is a block diagram illustrating a configuration of the controller 160 of the electronic apparatus 100 of the present disclosure.

Referring to FIG. 3, the controller 160 according to the present disclosure may include a connection list manager 161, a connection controller 163, and a performance evaluation unit 165.

The connection controller 163 may control the operation of the WiFi module 170 of the electronic apparatus 100 and may control, in parallel, the operation of the communication unit 110. For example, the connection controller 163 may make a control to activate the WiFi module 170 when there is a user input from the input unit 120, configured information, or an input for activating a particular program. Further, the connection controller 163 can control the nearby scanning process by using the activated WiFi module 170. When at least one wireless access point is found through the nearby scanning, the connection controller 163 collects the connection list 151 by requesting the connection list manager 161. Further, the connection controller 163 may check the information contained in the connection list 151 to determine whether the list includes information on a wireless access point having been marked as being in a deactivated state. The connection controller 163 may perform a connection trial based on information on the other wireless access points excluding the wireless access point having been marked as being in a deactivated state in the collected list.

Meanwhile, the connection controller 163 can identify wireless environment information of the wireless access points marked as being in a deactivated state. For example, when a wireless access point marked as being in a deactivated state has a Received Signal Strength Indicator (RSSI) larger than or equal to a pre-configured value, i.e. when the RSSI is smaller than or equal to −75 dB, the electronic apparatus 163 can switch the communication connection with the wireless access point into an activated state. Otherwise, the connection controller 163 can request the performance evaluation unit 165 to evaluate the performance of a wireless access point having an RSSI larger than or equal to a pre-configured value.

When it is determined that the connection to all wireless access points has failed, the connection controller 163 may stop attempting to connect to the wireless access points either temporarily or semi-permanently. Further, the connection controller 163 may control establishment of a communication channel based on the communication unit 110. The connection controller 163 may control scanning and connection trial to a wireless access point by a predetermined cycle according to a design scheme. Further, the connection controller 163 may perform scanning and validity checking of at least one wireless access point in a deactivated state by a predetermined cycle, determines whether to change the connection deactivated state, and performs a connection trial. In the validity checking, the validity may be approved, for example, when the RSSI of a wireless access point has a value higher than or equal to a pre-configured threshold or when a result of the performance evaluation has a value higher than or equal to a pre-configured threshold, as described above.

The connection controller 163 may shift a connection with a wireless access point into a deactivated state according to a pre-configured condition. In more detail, the connection controller 163 may determine whether at least one case, among a case in which an idle state without a signal transmitted or received through the WiFi module 170 continues for a predetermined time, a case in which an intensity of a received signal does not exceed a predetermined value, a case in which the WLAN transmission rate does not exceed a predetermined value, a case in which a signal having a pattern corresponding to a deactivation-vulnerable area has been received, and a case in which a Signal to Noise Ratio (SNR) has a value higher than or equal to a predetermined value, occurs. Further, when one case among the cases described above occurs, the connection controller 163 may determine whether conditions for deactivation and validity of the connection with a particular wireless access point are satisfied, and support a resultant deactivation. Among the cases, the case in which an idle state without a transmitted or received signal continues for a predetermined time may correspond to a case in which the idle state continues, for example, for at least two seconds or at least five seconds. Further, the case in which the WLAN transmission rate does not exceed a predetermined value may correspond to, for example, a case in which the WLAN transmission rate does not exceed 6 Mbps, a value defined in a particular standard. However, the present disclosure is not limited to those cases described above and includes change of the conditions according to various wireless environments. Further, when predetermined conditions are complexly satisfied as a result of sequential determination of the conditions described above, the connection controller 163 may deactivate the connection with the wireless access point. Further, in relation to the determination conditions described above, the connection controller 163 may extract parameters of each condition and combine the extracted parameters to determine the deactivation. The connection controller 163 described above can determine an actual user network use level based on a network response of the communication network 300 in an evaluation condition based on the determination conditions described above.

The connection list manager 161 may manage a connection list 151 for at least one wireless access point. To this end, the connection list manager 161 may collect information of wireless access points scanned according to the operation of the connection controller 163 and update the connection list 151 based on the collected information. Further, when a connection with a particular wireless access point is changed from an activated state to a deactivated state or from a deactivated state to an activated state under the control of the connection controller 163, the connection list manager 161 may responsively update the connection list 151. Also, the connection list manager 161 may manage information on reasons and history relating to the connection activated or deactivated state with wireless access points. Further, when outputting information to the display unit 140 according to a state change or in response to a user request, the connection list manager 161 may provide corresponding information together.

The performance evaluation unit 165 evaluates the performance of a particular wireless access point in response to a request from the connection controller 163. Specifically, the performance evaluation unit 165 can detect a link data rate between the electronic apparatus 100 and a wireless access point. Further, the performance evaluation unit 165 may evaluate an effective data rate of transmission through a wireless access point and the communication network 300 or a particular protocol-based data rate of transmission through the communication network 300 from the server apparatus 400. For example, the performance evaluation unit 165 may transmit a particular query to the server apparatus 400 through the communication network 300 connected to a wireless access point. Also, the performance evaluation unit 165 may measure a data rate based on a particular protocol connected to the communication network 300, such as a protocol of ARP, DNS, ICMP, or HTTP. Further, the performance evaluation unit 165 may determine whether a data rate of data transmitted or received based on the protocol is higher than or equal to a pre-configured value. The performance evaluation unit 165 may provide a result of the determination or evaluation to the connection controller 163. The controller 160 described above can achieve an exact communication scheme switching in performing a switching into another communication scheme, for example, an operation switching into the communication unit 110, so as to provide a more secure communication continuity based on the background processing.

Hereinafter, a communication connection control method of the present disclosure will be described. A communication connection control method of the present disclosure may include: collecting a wireless access point-related signal relating to a wireless environment of a wireless access point; determining whether the wireless access point-related signal has a value lower than or equal to a pre-configured value; evaluating a wireless communication performance including a performance of a wireless network connected to the wireless access point, according to a result of the determining; and making a control to activate or deactivate a communication connection based on the wireless access point, according to a result of the evaluating.

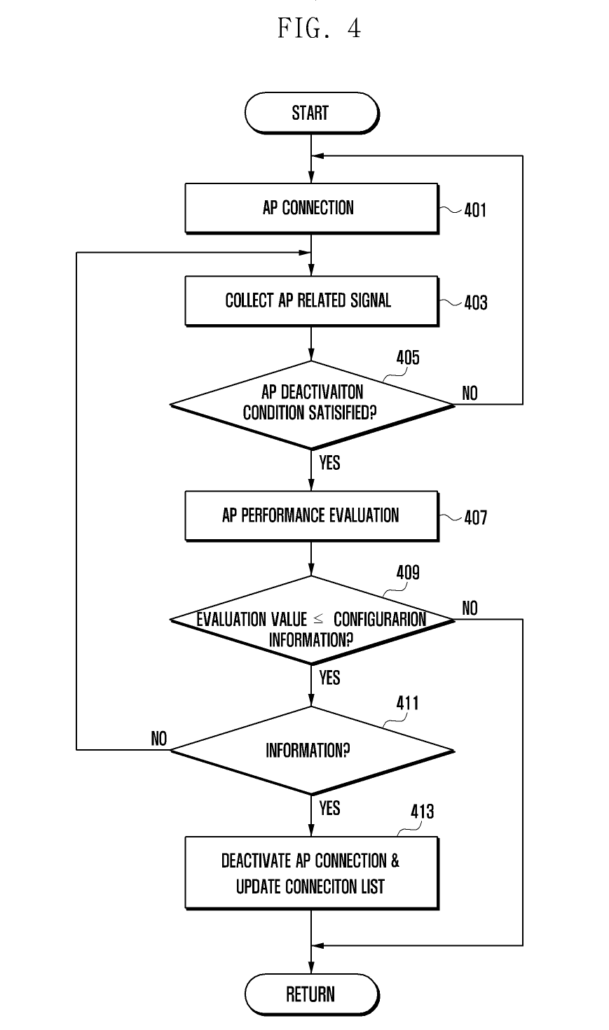

FIG. 4 is a flowchart illustrating a method of controlling an electronic apparatus for deactivating a connection with a particular wireless access point in a communication connection control method according to an embodiment of the present disclosure.

Referring to FIG. 4, a communication connection control method according to an embodiment of the present disclosure includes operation 401 in which the controller 160 of the electronic apparatus 100 may connect with or may maintain a connection with a particular wireless Access Point (AP). For the connection, the controller 160 activates the WiFi module 170 and performs a scanning process. Then, the controller 160 may connect with a wireless access point having a predetermined or good wireless environment among one or more wireless access points found through the scanning.

In operation 403, the electronic device 100 can collect an AP-related signal. In this operation, the controller 160 of the electronic device 100 may collect an AP-related signal either by a predetermined cycle or in response to a user request. In operation 403, the AP-related signal may include at least one of information on a signal reception idle state, information on an intensity of a received signal, information on a WLAN transmission rate, information on a pattern of a received signal, and information on Signal to Noise Ratio (SNR).

Next, in operation 405, the controller 160 may determine whether an AP connection deactivation condition is satisfied, based on the information described above. In this operation, when the AP connection deactivation condition is not satisfied, that is, when it is possible to perform a normal communication service operation, the controller 160 returns to a stage before operation 401 to re-perform the process therefrom.

Meanwhile, as a result of operation 405, when the AP connection deactivation condition is satisfied, the controller 160 may proceed to the next operation. In the operation, the controller 160 may determine whether a current situation corresponds to one case among a case in which a signal reception idle state is maintained for more than a predetermined time interval, a case in which an intensity of a signal from a wireless access point does not exceed a predetermined value, a case in which a WLAN transmission rate does not exceed a predetermined value, a case in which a signal having a pre-defined pattern corresponding to a deactivation-vulnerable area or a deactivation-vulnerable state has been received, and a case in which a Signal to Noise Ratio (SNR) has a value higher than or equal to a predetermined value. When each of the cases described above is maintained for a pre-defined time, the controller 160 may operate to approve the corresponding case. Meanwhile, the signal having the pattern corresponding to a deactivation-vulnerable area or a deactivation-vulnerable state may be acquired through experiments or statistically calculated. Otherwise, a signal having an amplitude smaller than or equal to a predetermined threshold or a signal including noise exceeding a predetermined threshold may be defined as a deactivation-vulnerable signal.

As a result of operation 405, when the AP connection deactivation condition is satisfied, the controller 160 may perform AP performance evaluation in operation 407. In performing the AP performance evaluation, the controller 160 may collect information on a data transmission rate based on at least one protocol among various protocols as described above. Further, the controller 160 may collect information on a data rate of a communication network connected to a wireless access point or information on a data rate of a communication network and a server apparatus.

Then, the controller 160 may proceed to operation 409 in which the controller may determine whether the AP performance evaluation value, i.e. the data rate, is smaller than or equal to a value indicating configuration information. In this operation, when the data rate is larger than the value indicating the configuration information, i.e. when the AP performance has a data rate large enough to support a normal communication service, the controller 160 may determine that an error has occurred, and perform a returning operation. For example, the controller 160 may return to operation 401, so as to support re-execution of the process from operation 401.

As a result of operation 409, when the evaluation value is smaller than or equal to the value indicating the configuration information, the controller 160 proceeds to operation 411 in which the controller determines whether the condition is valid. That is, the controller 160 may determine whether the state in which the AP performance evaluation value is not good is repeated by more than a pre-defined number of times. When the state is repeated by a number of times smaller than or equal to a pre-defined number, the controller 160 may return to operation 403, so as to support re-execution of the process from operation 403.

Meanwhile, as a result of operation 409, when the evaluation value is smaller than or equal to the value indicating the configuration information, the controller 160 may directly proceed to operation 413. However, in order to consider a temporarily wireless environment change in the process of collecting the AP related signal, the electronic apparatus 100 may perform operation 411 to determine whether the deactivation condition is repeatedly detected by more than a predetermined number of times or whether the state of bad performance evaluation is repeated. As a result, the controller 160 can support a more adaptive handling of a change in the wireless environment. Meanwhile, in order to achieve a design more sensitive to a change in the wireless environment, operation 411 may be omitted so that only operation 409 may be performed after operation 407. Further, the process may be designed to directly proceed to operation 413 when the evaluation value is smaller than the value indicating the configuration information as a result of the determination in operation 409.

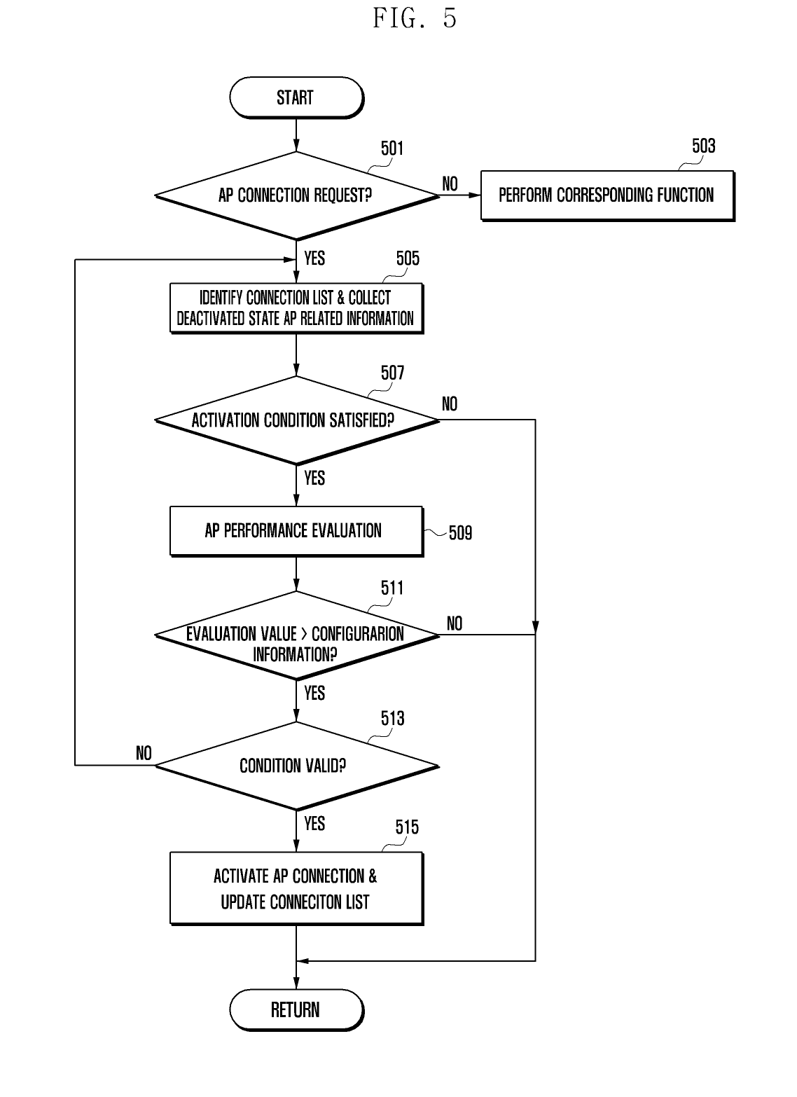

Meanwhile, as result of the determination in operation 411, when the condition is valid, that is, when the AP connection deactivation condition is satisfied by more than a predetermined number of times, the controller 160 may proceed to operation 413 in which the controller may deactivate the AP connection and update the connection list 151. In relation to the AP connection deactivation, the controller 160 may deactivate the connection with the corresponding wireless access point and mark the connection with the corresponding wireless access point as a deactivated state in the connection list 151. Otherwise, the controller 160 may mark the connection with the corresponding wireless access point as a deactivated state in the connection list 151 while maintaining the connection with the corresponding wireless access point. For example, the controller 160 may process the marking of a particular wireless access point among a plurality of wireless access points as a deactivated state, based on release of the connection. Further, when only one wireless access point is found in the search process, the controller 160 may maintain the connection with the corresponding wireless access point while processing the connection as a deactivated state. In the present disclosure, the deactivated state may be a state in which use of a communication service through a particular wireless access point is not performed. Further, the activated state may be a state in which it is possible to use a communication service through a particular wireless access point. Meanwhile, in the course of performing a WiFi connection through one wireless access point, when it is determined that the connection with the wireless access point is in a deactivated state, the controller 160 may control the communication unit 110 to perform a communication connection. Further, the controller 160 may determine whether to perform activation through periodic checking of a wireless access point as described below with reference to FIG. 5.

Meanwhile, when a result value of the performance evaluation obtained in operation 407 is lower than or equal to a configured value, the controller 160 of the electronic apparatus may proceed to operation 403 and re-execute the process after operation 403 according to whether the condition is valid as a result of the determination in operation 411. In this event, the controller 160 may prevent the performance evaluation in operation 407 from being performed again in the re-executed process. In more detail, the controller 160 first performs a performance evaluation in response to occurrence of an AP deactivation condition. When a result value of the performance evaluation is smaller than or equal to a pre-configured value and the condition is not valid, the controller 160 may proceed to operation 403 and then determine whether the AP deactivation condition still occurs. Further, when the AP deactivation condition still occurs, the controller 160 may omit operation 407 and operation 409 and directly proceed to operation 413 in which the controller may deactivate the connection with the corresponding AP and update the connection list.

FIG. 5 is a flowchart illustrating a method of controlling an electronic apparatus for activating a connection with a wireless access point marked as being in a deactivated state in a communication connection control method according to an embodiment of the present disclosure.

Referring to FIG. 5, in operation 501, the controller 160 determines whether there is an AP connection request. That is, the controller 160 may determine whether a request for connection with a wireless access point is received, based on the WiFi module 170. In this operation, when there is no AP connection request, the controller 160 may proceed to operation 503 in which the controller performs a control to support functions of the electronic apparatus according to an input signal or configured information. For example, the controller 160 may perform a control to establish a communication channel based on the communication unit 110 and support use of a particular communication service.

When an AP connection request has occurred, the controller 160 may activate the WiFi module 170 and scan the surroundings to search for an AP. Then, the controller 160 proceeds to operation 505 in which the controller can identify the connection list 151 and determine whether the searched information includes deactivated AP related information. When the searched information includes deactivated AP related information, the controller 160 proceeds to operation 507 in which the controller can determine whether a condition for activation of connection with the corresponding AP is satisfied.

That is, the controller 160 checks the searched AP related information to identify RSSI information of an AP marked as being in a deactivated state. For example, when a connection with a particular AP is in a deactivated state and the controller 160 receives an input signal for AP connection or is requested for AP state examination according to passage of a pre-configured period, the controller 160 may perform measurement of a signal reception intensity of the corresponding AP, etc. to determine whether an activation condition is satisfied.

Meanwhile, as a result of determination in operation 507, when the signal reception intensity is higher than or equal to a pre-configured value, the controller 160 proceeds to operation 509 in which the controller may perform an AP performance evaluation. In operation 507, when the signal reception intensity in the deactivation condition is higher than or equal to a pre-configured value, the controller 160 may determine that the activation condition is satisfied. For example, when the connection has been deactivated with reference to an RSSI of −75 dB, the activation condition may be a condition that the received signal intensity has been improved by 10 dB or more.

Further, as a result of determination in operation 511, when the AP performance evaluation value is larger than a value indicating configuration information, that is, when a good AP performance evaluation value has been detected, the controller 160 may proceed to operation 513 in which the controller can determine whether the condition is valid. As a result of the determination in operation 511, when a performance evaluation of a particular wireless access point is poor, the controller 160 may perform a return process for returning functions of the electronic apparatus 100 and maintain the connection deactivation with the wireless access point. In addition, the controller 160 may perform a control to operate a communication service using the communication unit 110 or inspect another wireless access point.

When a good performance evaluation result is identified by more than a predetermined number of times or is maintained for more than a predetermined time interval as a result of the determination in operation 513, the controller 160 may switch the deactivated state into an activated state. In the condition validity determining operation, the controller 160 may support determination on whether a communication service of a particular AP has actually been improved, based on an effective performance evaluation result of the AP. In the operation 513 as described above, the validity determination is performed in order to adaptively cope with a rapidly changing wireless environment and may correspond to an operation of determining whether the received signal intensity is constantly maintained to be higher than or equal to a configured value. The AP performance evaluation may be performed in the same way as that of the AP performance evaluation of FIG. 4.

As a result of the determination in operation 513, when the condition is not valid, that is, when a signal having a reception intensity higher than or equal to a configured value has been detected by less than or equal to a predetermined number of times, the controller 160 may proceed to operation 505 and re-execute the process therefrom.

Meanwhile, as a result of the determination in operation 507, when the activation condition is not satisfied, the controller 160 does not perform a wireless access point-based operation and may perform a return operation to support a communication service operation based on the communication unit 110. Meanwhile, as result of the determination in operation 513, when the condition is valid, the controller 160 may proceed to operation 515 in which the controller may activate the AP connection and update the connection list 151. That is, the controller 160 may shift a connection with an AP having a connection in a deactivated state into an activated state.

Meanwhile, as a result of the determination in operation 511, when the performance evaluation value is higher than a configured value, the controller 160 of the electronic apparatus may proceed to operation 513 to determine the validity of the condition. When the performance evaluation value does not exceed the configured value, the controller 160 may return to operation 505 and re-execute the process after operation 505. In the re-execution, when the activation condition is maintained by performing only operation 507, the controller 160 may omit operation 509, operation 511, and operation 513 and directly proceed to operation 515 in which the controller may perform a control to switch the deactivated state of the connection with the corresponding AP into an activated state and update the connection list.

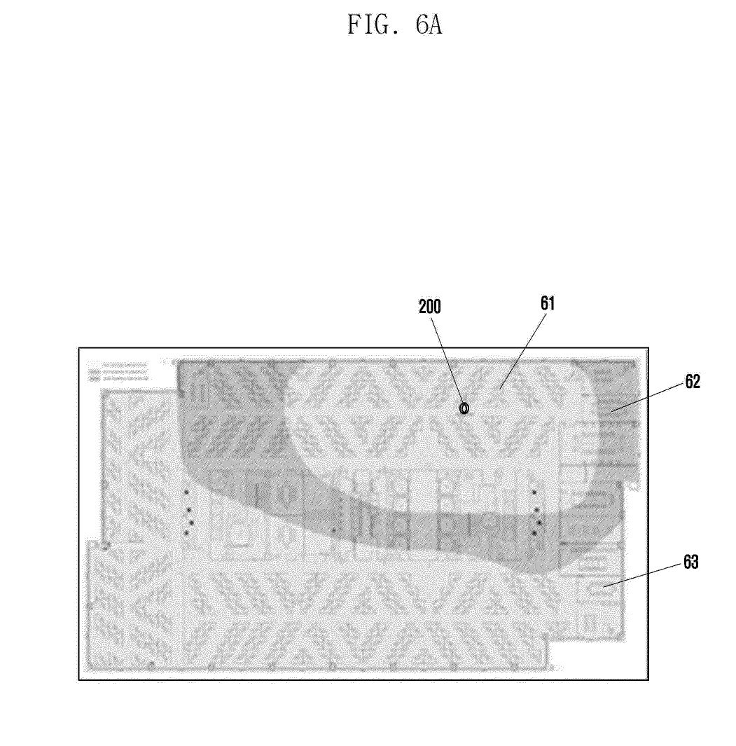

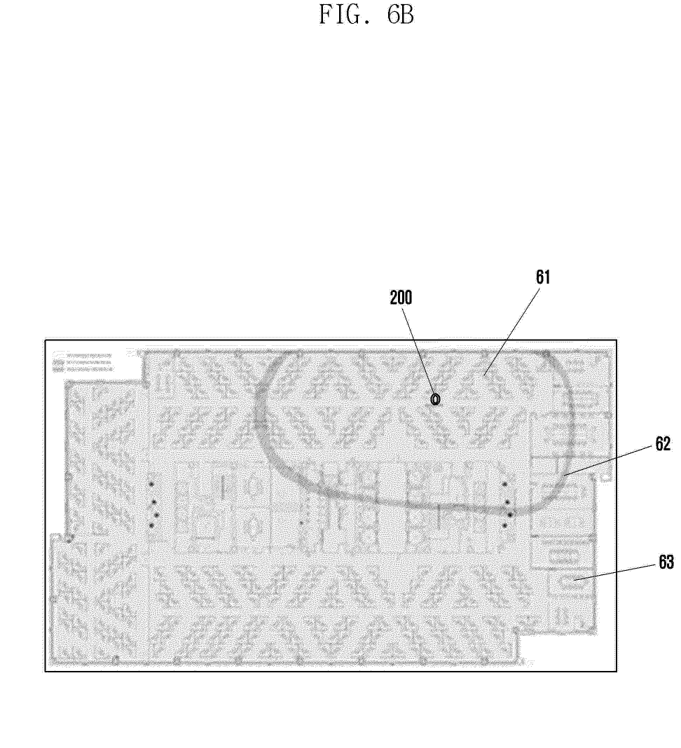

FIGS. 6A and 6B illustrate local communication connection characteristics based on a wireless access point according to an embodiment of the present disclosure.

Especially, FIG. 6A illustrates a range allowing communication in a state without an actual communication connection control with the wireless access point 200. As illustrated in FIG. 6A, a good communication area 61, a neutral communication area 62, and a communication shift area 63 may appear around the wireless access point 200. The good communication area 61 may be an area which allows execution of communication using the wireless access point 200. The communication shift area 63 may be an area which does not allow execution of communication based on the wireless access point 200. Therefore, the communication shift area 63 may be an area allowing execution of communication using another communication scheme, such as a base station-based 3G or 4G communication scheme. Otherwise, the communication shift area 63 may be an area which allows execution of communication through another wireless access point.

The neutral communication area 62 may be an area in which a communication service quality is actually low in spite of a relatively high value detected as a value indicating the communication state with the wireless access point 200. For example, the neutral communication area 62 may be an area in which a communication service quality has a value smaller than or equal to a value configured as a deactivation condition although the received signal intensity in the communication with the wireless access point 200 has a value higher than a predetermined value. In this area, since an effective data rate between the wireless access point 200 and the communication network 300 or a data rate based on a particular protocol is lower than or equal to a predetermined value, the electronic apparatus 100 thus has difficulty in performing normal data transmission or reception or has a relatively large delay in comparison with the good communication area 61 or the communication shift area 63 used for another communication scheme.

Referring to FIG. 6B, the neutral communication area 62 is formed to be narrower that the neutral communication area in FIG. 6A. Therefore, there is a higher chance to use a communication service in an area with a good effective data rate. That is, the electronic apparatus 100 can use a communication service through the wireless access point 200 in the good communication area 61 and can use a communication service by using the communication unit 110 based on 3G or 4G in the communication shift area 63. As a result, without a delay in the neutral communication area 62, the electronic apparatus 100 can rapidly and exactly provide a communication service with a good quality. Further, the electronic apparatus 100 can suppress occurrences of unnecessary switching between the wireless access point 200 and the communication unit 110 in the neutral communication area 62, so as to minimize the waste of electric power.

As described above, a communication connection control method and an apparatus supporting the same according to an embodiment of the present disclosure enables provision of a communication service with a good quality by operating a communication module which enables effective data transmission and reception. Further, the present disclosure can support a resultant effective electric power operation.

The above-described electronic apparatus may further include various additional modules according to a form of implementation. Specifically, when the electronic apparatus is a communication electronic apparatus, the electronic apparatus may further include elements which have not been described above, such as a short-range communication module for short-range communication, an interface for transmitting and receiving data in a wired communication scheme or a wireless communication scheme of the electronic apparatus, an Internet communication module for communicating with an Internet network and performing an Internet function, a digital broadcasting module for receiving and reproducing a digital broadcast signal, and the like. These components may be variously modified according to the convergence trend of digital devices, and cannot be entirely enumerated. However, the electronic device may further include elements equivalent to the above-described elements. Also, it goes without saying that, in the electronic apparatus, a particular configuration may be excluded from the above-described configuration or may be replaced by another configuration according to various embodiments of the present disclosure. This may be easily understood by those skilled in the art to which the present disclosure pertains.

In addition, the electronic apparatus according to an embodiment of the present disclosure may include all information and communication devices and multimedia devices such as a Portable Multimedia Player (PMP), a digital broadcasting player, a Personal Digital Assistant (PDA), a music player (for example, an MP3 player), a portable game terminal, a smart phone, a laptop computer, and a handheld PC and application devices thereof as well as all mobile communication terminals operating based on communication protocols corresponding to various communication systems.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A communication connection control method comprising:
collecting a wireless access point-related signal relating to a wireless environment of a wireless access point;
determining whether the wireless access point-related signal is in a state having a value lower than or equal to a pre-configured value;
performing a wireless communication performance evaluation of a communication network connected to the wireless access point according to a result of the determining; and
performing a control to deactivate a communication connection through the wireless access point according to a result of the wireless communication performance evaluation.

2. The communication connection control method of claim 1, wherein the collecting of the wireless access point-related signal comprises collecting at least one type of information among information on a signal reception idle state, information on an intensity of a received signal, information on a WLAN transmission rate, information on a pattern of a received signal, and information on a Signal to Noise Ratio (SNR).

3. The communication connection control method of claim 2, wherein the determining comprises at least one determining among:
determining whether a signal idle state without a received signal is maintained for a predetermined time interval;
determining whether an intensity of a received signal has a value lower than or equal to a predetermined value;
determining whether a WLAN transmission rate has a value lower than or equal to a predetermined value;
determining whether a signal having a pattern corresponding to a deactivation-vulnerable area has been received; and
determining whether a Signal to Noise Ratio (SNR) has a value lower than or equal to a predetermined value.

4. The communication connection control method of claim 3, further comprising:
re-performing the at least one determining when a result of the wireless communication performance evaluation has a value lower than or equal to a pre-configured value,
wherein the performing of the control comprises:
performing a control to re-perform the wireless communication performance evaluation when a predetermined condition is satisfied as a result of the at least one determining and deactivate a connection with the wireless access point according a result of the re-performed wireless communication performance evaluation; or
performing a control to deactivate a connection with the wireless access point when a predetermined condition is satisfied as a result of the at least one determining.

5. The communication connection control method of claim 1, wherein the performing of the wireless communication performance evaluation comprises at least one of:
transmitting a pre-configured test signal to a particular server apparatus connected to the communication network and receiving response data according to the test signal; and
evaluating a data transmission rate based on a particular protocol through the wireless access point and the communication network.

6. The communication connection control method of claim 1, further comprising generating and managing a connection list including information on a connection activated state or a connection deactivated state of a connection with the wireless access point.

7. The communication connection control method of claim 6, further comprising outputting the information on the connection activated state or the connection deactivated state of the connection with the wireless access point.

8. A communication connection control method comprising:
collecting a signal relating to a wireless environment of a wireless access point in a connection state configured to a deactivated state;
determining whether the signal relating to the wireless environment of the wireless access point has an intensity higher than a pre-configured value;
performing a wireless communication performance evaluation of a communication network connected to the wireless access point according to a result of the determining; and
performing a control to activate a communication connection based on the wireless access point according to a result of the wireless communication performance evaluation.

9. The communication connection control method of claim 8, wherein the collecting of the signal comprises collecting information on received signal intensity from the wireless access point.

10. The communication connection control method of claim 9, further comprising re-performing the collecting of the information on the received signal intensity when a result of the wireless communication performance evaluation has a value higher than a pre-configured value,
wherein the performing of the control comprises:
performing a control to re-perform the wireless communication performance evaluation when the received signal intensity is higher than a pre-configured value and activate a connection with the wireless access point according a result of the re-performed wireless communication performance evaluation; or
performing a control to activate a connection with the wireless access point when the received signal intensity is higher than a pre-configured value.

11. The communication connection control method of claim 8, wherein the performing of the wireless communication performance evaluation comprises at least one of:
transmitting a pre-configured test signal to a particular server apparatus connected to the communication network and receiving response data according to the test signal; and
evaluating a data transmission rate based on a particular protocol through the wireless access point and the communication network.

12. The communication connection control method of claim 8, further comprising at least one:
generating and managing a connection list including information on a connection activated state or a connection deactivated state of a connection with the wireless access point; and
outputting the information on the connection activated state or the connection deactivated state of the connection with the wireless access point.

13. An electronic apparatus for performing a communication connection control, the electronic apparatus comprising:
a WiFi module configured to collect a wireless access point-related signal relating to a wireless environment of a wireless access point; and
a controller configured to determine whether the wireless access point-related signal is in a state having a value lower than or equal to a pre-configured value, to perform a wireless communication performance evaluation of a communication network connected to the wireless access point according to a result of the determining, and to perform a control to deactivate a communication connection based on the wireless access point according to a result of the wireless communication performance evaluation.

14. The electronic apparatus of claim 13, wherein the WiFi module is further configured to collect at least one type of information among information on a signal reception idle state, information on an intensity of a received signal, information on a WLAN transmission rate, information on a pattern of a received signal, and information on a Signal to Noise Ratio (SNR).

15. The electronic apparatus of claim 14, wherein the controller determines at least one state among a state in which a signal idle state without a received signal is maintained for a predetermined time interval, a state in which an intensity of a received signal has a value lower than or equal to a predetermined value, a state in which a WLAN transmission rate has a value lower than or equal to a predetermined value, a state in which a signal having a pattern corresponding to a deactivation-vulnerable area has been received; and a state in which a Signal to Noise Ratio (SNR) has a value lower than or equal to a predetermined value.

16. The electronic apparatus of claim 15, wherein the WiFi module is further configured to re-collect the at least one type of information when a result of the wireless communication performance evaluation has a value lower than or equal to a pre-configured value,
wherein the controller performs a control to:
re-perform the wireless communication performance evaluation when the at least one state is determined and deactivate a connection with the wireless access point according a result of the re-performed wireless communication performance evaluation; or
deactivate a connection with the wireless access point when the at least one state is determined.

17. The electronic apparatus of claim 13, wherein the controller performs a communication connection control to:
perform the wireless communication performance evaluation by transmitting a pre-configured test signal to a particular server apparatus connected to the communication network and receiving response data according to the test signal; or
perform the wireless communication performance evaluation based on a data transmission rate according to a particular protocol through the wireless access point and the communication network.

18. The electronic apparatus of claim 13, further comprising:
at least one of:
a storage unit configured to store a connection list including information on a connection activated state or a connection deactivated state of a connection with the wireless access point;
a display unit configured to output the information on the connection activated state or the connection deactivated state of the connection with the wireless access point; and
a communication unit configured to support a communication service according to another communication scheme when the connection with the wireless access point is shifted into a deactivated state.

19. An electronic apparatus for performing a communication connection control, the electronic apparatus comprising:
a WiFi module configured to collect a signal relating to a wireless environment of a wireless access point in a connection state configured to a deactivated state; and
a controller configured to determine whether the signal relating to the wireless environment of the wireless access point has an intensity higher than a pre-configured value, to perform a wireless communication performance evaluation of a communication network connected to the wireless access point according to a result of the determining, and to perform a control to activate a communication connection based on the wireless access point according to a result of the wireless communication performance evaluation.

20. The electronic apparatus of claim 19, wherein the WiFi module is further configured to collect information on received signal intensity from the wireless access point.

21. The electronic apparatus of claim 20, wherein the WiFi module is further configured to re-collect the information on the received signal intensity when a result of the wireless communication performance evaluation has a value higher than a pre-configured value,
wherein the controller performs a control to:
re-perform the wireless communication performance evaluation when the received signal intensity is higher than a pre-configured value and activate a connection with the wireless access point according a result of the re-performed wireless communication performance evaluation; or
activate a connection with the wireless access point when the received signal intensity is higher than a pre-configured value.

22. The electronic apparatus of claim 19, wherein the controller performs a communication connection control to:
evaluate the wireless communication performance evaluation by transmitting a pre-configured test signal to a particular server apparatus connected to the communication network and receiving response data according to the test signal; or
evaluate the wireless communication performance based on a data transmission rate according to a particular protocol through the wireless access point and the communication network.

23. The electronic apparatus of claim 19, further comprising:
at least one of:
a storage unit configured to store a connection list including information on a connection activated state or a connection deactivated state of a connection with the wireless access point;
a display unit configured to output the information on the connection activated state or the connection deactivated state of the connection with the wireless access point; and
a communication unit configured to release a communication channel based on another communication scheme when the connection with the wireless access point is shifted from a deactivated state to an activated state.
